(19) United States
(12) Patent Application Publication
(10) Pub. No.: US 2023/0222458 A1
(43) Pub. Date: Jul. 13, 2023

(54) COMPUTATION OF AN AMOUNT OF CRYPTO CURRENCY TOKENS FOR USE IN CREATION AND/OR ANNULMENT PROCEDURE

(71) Applicant: Robert Bosch GmbH, Stuttgart (DE)

(72) Inventor: Alexander Poddey, Wiernsheim (DE)

(21) Appl. No.: 18/063,497

(22) Filed: Dec. 8, 2022

(30) Foreign Application Priority Data
Jan. 12, 2022 (DE) 10 2022 200 256.3

(51) Int. Cl. G06Q 20/06

(52) U.S. Cl. CPC G06Q 20/0655

(57) ABSTRACT

A computer-implemented method for maintaining crypto tokens of a first type. A creation and annulment procedure are implemented that may integrate a bonding curve and a fee term starting from the current supply size to a new supply size to determine an amount of crypto tokens of a second type. A creation request for creating crypto tokens of the first type may indicate a second amount of second type crypto tokens. A corresponding amount of first type crypto tokens may be computed by estimating the first amount.

### CROSS REFERENCE

The present application claims the benefit under 35 U.S.C. § 119 of German Patent Application No. DE 10 2022 200 256.3 filed on Jan. 12, 2022, which is expressly incorporated herein by reference in its entirety.

### FIELD

The present invention relates to a computer-implemented method for maintaining crypto tokens of a first type, a server device, a client device, and a computer readable medium.

### BACKGROUND INFORMATION

A decentralized transaction system, transaction database or distributed ledger is any protocol in computer networks that brings about consensus regarding its transactions and their sequence. A common form of such a system is based on a blockchain and forms the basis of many so-called cryptocurrencies. In a cryptocurrency, cryptographic tokens are distributed across multiple clients. The clients can transfer the tokens among each other, or to and from a market maker. Cryptography and distributed ledger systems ensure that a transfer cannot easily be forged or repudiated.

International Patent Application No. WO 2019/043668 A1 describes a conventional blockchain, in this case, to track cryptocurrency tokens. Transactions related to the tokens, such as token creation or destruction are visible on the blockchain.

A distributed ledger such as a blockchain provides a secure transfer system. This allows, e.g., tokens of a first type to be exchanged for tokens of a second type. Colloquially, a token of the first type is bought, and has a price as an amount of tokens of the second type. Advanced cryptocurrencies use a mechanism known as “curved bonding”, according to which a function known as a bonding curve is algorithmically defined, which influences the price of units (tokens) of the currency depending on the current supply of tokens. Price is used loosely here to indicate the tokens that are exchanged, which do not necessarily have a monetary value. A token may represent any limited resource, e.g., access to computation resources or the like, and the cryptocurrency may be used to regulate access.

The conventional system includes managing a cryptocurrency with curved bonding. In the conventional method, a plurality of users are provided with an in-marketplace wallet, suitable for storing linked digital tokens that are linked in value to cryptocurrency tokens and that are required to transact on a digital marketplace platform. A cryptocurrency reserve is provided suitable for storing a plurality of cryptocurrency tokens. In response to a user purchasing linked digital tokens from a marketplace store, linked digital tokens are transferred to the in-marketplace wallet of the user and an equivalent value of cryptocurrency tokens are transferred to the cryptocurrency reserve. In response to a user withdrawing a number of linked digital tokens from the in-marketplace wallet of the user, the desired number of linked digital tokens is removed from the user's in-marketplace wallet and an equivalent value of cryptocurrency tokens is transferred from the cryptocurrency reserve to an out-of-marketplace wallet of the user, the out-of-marketplace wallet suitable for storing cryptocurrency tokens outside of the marketplace platform.

FIG. 10 of International Patent Application No. WO 2019/043668 A1 shows a graph illustrating how bonding of tokens may be applied. Token bonding is used to introduce a hierarchy of tokens which are fundamentally related to each other. Token bonding is a means of token generation with a predefined price-supply relationship or bonding curve. This may be achieved through a smart contract: users deposit a reserve currency into the smart contract address, and in turn receive newly-minted tokens. The deposit may be locked up, to be returned to sellers of the token at a later date. The price the user pays per token may be dictated by the aforementioned curve. At any point, users may be able to exchange their minted tokens for the original reserve currency at a price dictated by the same curve. Sell and buy curves may be distinct.

For an additional x tokens to be purchased, the smart contract may look up the appropriate point on the curve based on existing circulating supply and determine the amount to be paid in the native token for the bundle of x tokens to be generated. A similar process may be provided for selling tokens which destroys these tokens by removing them from circulation and moving the total token supply backward along the bonding curve. Since the token may be 100% collateralized, the system may provide enough reserve currency stored to compensate the sold tokens. The conventional bonding curve is defined as

$$f ( x ) = \frac{x}{c ( a + {x}^{b} )} ,$$

where a>0 and 0.5<b<1; c>1

The integral of this function involves the evaluation of a hypergeometric function, which does not have a closed form.

### SUMMARY

A disadvantage of using a bonding curve is that there is no fixed exchange ratio between tokens of the first type and of the second type. The amount of second type tokens that are needed to obtain a given amount of first type tokens depends on an integral over a typically non-linear bonding curve. Moreover, the start and end points of the integration are not fixed but depend on the current supply of first type tokens. The current supply size can change from moment to moment if creation or annulment requests are processed. In practice however, a user may want to acquire an amount of first type tokens for a given amount of second type tokens. Because of this, for a user device it is not really possible to make this estimation with any precision. In an example embodiment of the present invention, a creation request for creating crypto tokens of the first type may indicate a second amount of crypto tokens of the second kind. To accommodate this, a computation is made that estimates the first amount wherein an integral of the creating bonding curve from the current supply size to the current supply size increased with the first amount equals the indicated second amount to within a threshold. It will often not be possible to solve exactly for a given amount of second type tokens, given the non-linearity of the integral of the bonding curve, but an approximation is possible. For example, this can be done by using an approximation algorithm.

For example, the approximation algorithm may solve the equation y=∫ₛ^{s+x}Γ(z)dz for x, wherein y is the indicated second amount of second type tokens, Γ( ) is the bonding curve, s is the current supply size and x is the first amount of first type crypto tokens.

Once the first amount has been computed, a transaction can be created for it, e.g., the transaction can be included in a block and put on a distributed ledger. This step need not differ from conventional transactions that are specified in first type tokens. For example, the current supply size may be increased with the first amount of crypto tokens of the first type, the first amount of first type crypto tokens of the first type may be transferred. The second amount of second type crypto tokens may also be transferred; although this could also be done before the estimation is started. For example, one could also return a surplus of second amount of crypto tokens, in case the above estimation is an under-estimation. For example, the approximation may solve instead, y=ε+∫ₛ^{s+x}Γ(z)dz, for x and ε, wherein ε is a positive number less than a threshold. The number ε allows some flexibility which may be needed to obtain a valid solution. Although the first or second amount of tokens does not need to be an integral value, they typically cannot be subdivided indefinitely. For example, the amounts may be dyadic or binary rationals, with an upper limit on the size of the denominator.

In an example embodiment of the present invention, the creation procedure is implemented in a smart contract. For example, a creation procedure may be defined in the smart contract that defines the transferring of first type tokens and/or the maintaining of the supply size. Interestingly, the approximation algorithm need not be a part of the smart contract. Instead, the first amount can be computed privately by a server device, off-chain. Although this means that the approximation algorithm is not transparent and cannot be verified by other server devices, this is in fact not necessary, because the end-result can be viewed as a transaction as if it was specified in first type crypto tokens. The resulting transfer can be verified, e.g., by other server devices. It is a particular advantage that the approximation can be done off-chain, that is by chain-logic, without the individual computation steps being visible on a distributed ledger, but only, say, the end-result. This is because, on-chain computation is expensive and resource intensive.

In an example embodiment of the present invention, the bonding curve is defined as a sequence of multiple curve segments. This has the advantage that the definition of the curve segments can be simpler. For example, the bonding curve in the background is so complex, that it does not even allow for a closed form primitive. This makes integrating complex, but solving the above integral equation becomes even more complex. For example, the segment may be polynomial, e.g., Bezier splines. Their integral can be expressed in closed form, e.g., also as polynomials. This allows for computation of the integral for a particular amount of first type tokens by direct substitution, and allows for much quicker approximation as well.

An aspect of the present invention is a method for maintaining crypto tokens of the first type. An aspect of the present invention is a system for maintaining crypto tokens of the first type. For example, the system may comprise one or more server devices and one or more client devices. An aspect of the present invention is a method for maintaining crypto tokens of the first type for use on a server device. An aspect is a method for maintaining crypto tokens of the first type for use on a client device.

An example embodiment of the method of the present invention may be implemented on a computer as a computer implemented method, or in dedicated hardware, or in a combination of both. Executable code for an embodiment of the method may be stored on a computer program product. Examples of computer program products include memory devices, optical storage devices, integrated circuits, servers, online software, etc. Preferably, the computer program product comprises non-transitory program code stored on a computer readable medium for performing an embodiment of the method when said program product is executed on a computer.

In an example embodiment of the present invention, the computer program comprises computer program code adapted to perform all or part of the steps of an embodiment of the method when the computer program is run on a computer. Preferably, the computer program is embodied on a computer readable medium.

Another aspect of the present invention is a method of making the computer program available for downloading.

### BRIEF DESCRIPTION OF DRAWINGS

Further details, aspects, and embodiments of the present invention will be described, by way of example only, with reference to the figures. Elements in the figures are illustrated for simplicity and clarity and have not necessarily been drawn to scale. In the figures, elements which correspond to elements already described may have the same reference numerals.

FIG. 1A schematically shows an example of an embodiment of a client device of the present invention.

FIG. 1B schematically shows an example of an embodiment of a server device of the present invention.

FIG. 1C schematically shows an example of an embodiment of a cryptographic token system of the present invention.

FIG. 2A schematically shows an example of an embodiment of a bonding curve, according to the present invention.

FIG. 2B schematically shows an example of an embodiment of a bonding curve, according to the present invention.

FIG. 2C schematically shows an example of an embodiment of a bonding curve, according to the present invention.

FIG. 2D schematically shows an example of an embodiment of a bonding curve, according to the present invention.

FIG. 3 schematically shows an example of an embodiment of a blockchain, according to the present invention.

FIG. 4 schematically shows an example of an embodiment of a method for maintaining crypto tokens of a first type, according to the present invention.

FIG. 5A schematically shows a computer readable medium having a writable part comprising a computer program according to an embodiment, according to the present invention.

FIG. 5B schematically shows a representation of a processor system according to an embodiment, according to the present invention.

### REFERENCE SIGNS LIST

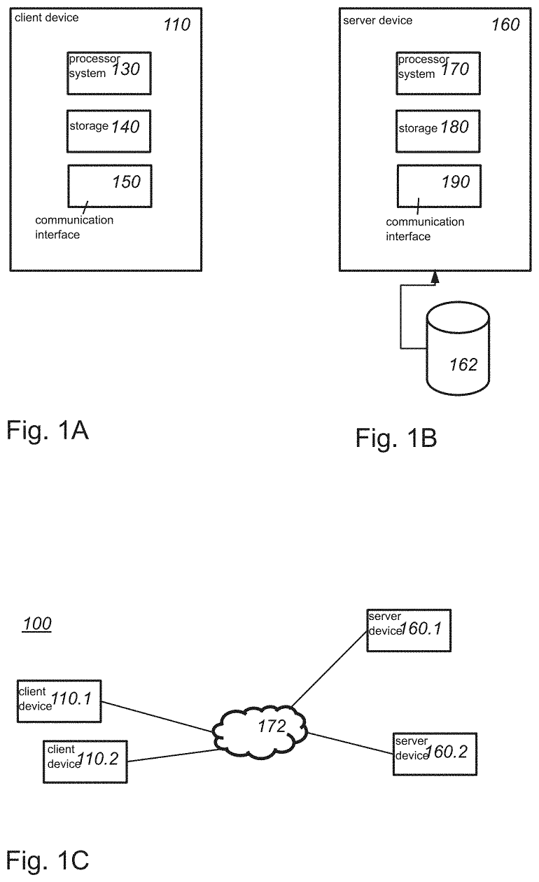

The following list of references and abbreviations corresponds to FIGS. 1A-3, 5A, 5B, and is provided for facilitating the interpretation of the drawings and shall not be construed as limiting the present invention.
100 a crypto token system
110, 110.1, 110.2 a client device
130 a processor system
140 a storage
150 a communication interface
160, 160.1, 160.2 a server device
162 a database
170 a processor system
180 a storage
190 a communication interface
172 a computer network
210 a blockchain
211-215 a block
220 a smart contract
221 a create procedure
222 an annulment procedure
223 an update procedure
231-234 a state
241-242 a crypto token transactions
251-253 a point in time
301 a bonding curve
311 an amount of crypto tokens of the first type
312 an amount of crypto tokens of the second type
313 an amount of crypto tokens of the second type
314 an amount of crypto tokens of the second type
X1, X2 an amount of crypto tokens of the first type
315 current supply of crypto tokens of the first
type
330 state information
321-323 curve segment parameters
1000, 1001 a computer readable medium
1010 a writable part
1020 a computer program
1110 integrated circuit(s)
1120 a processing unit
1122 a memory
1124 a dedicated integrated circuit
1126 a communication element
1130 an interconnect
1140 a processor system

### DETAILED DESCRIPTION OF EXAMPLE EMBODIMENTS

While the present invention is susceptible of embodiment in many different forms, there are shown in the figures and will herein be described in detail one or more specific embodiments, with the understanding that the present disclosure is to be considered as exemplary of the principles of the present invention and not intended to limit it to the specific embodiments shown and described.

In the following, for the sake of understanding, elements of embodiments of the present invention are described in operation.

However, it will be apparent that the respective elements are arranged to perform the functions, e.g., procedures, being described as performed by them.

Further, the present invention that is presently disclosed is not limited to the embodiments only, but also includes every other combination of features described herein or recited in mutually different embodiments.

FIG. 1A schematically shows an example of an embodiment of a client device 110. FIG. 1B schematically shows an example of an embodiment of a server device 160.

For example, server device 160 may be configured to maintain crypto tokens of a first type. For example, server device 160 may be configured to receive a creation request for creating tokens of the first type, or an annulment request for annulling tokens of the first type, or an update request to update a bonding curve. In response, server device 160 may include data reflecting the transaction(s) in a new block on a distributed ledger, e.g., on a blockchain. The information included in a block may reflect the transaction, showing that a user obtained the tokens or that the tokens were removed from the user, or state information of the contract, e.g., including a new bonding curve definition or a new current supply, etc. The information may show that the tokens are no longer valid.

First type tokens are created or annulled in exchange for second type tokens. The amount of second type tokens is determined by integrating a bonding curve, e.g., a creating bonding curve for creation requests, an annulling bonding curve for annulling request. Interestingly, server 160 is configured to receive requests specifying an amount of second type tokens instead of first type tokens. To accommodate these types of requests, server 160 is configured to compute a first amount of crypto tokens of the first type. For example, server 160 may execute an approximating algorithm for estimating the first amount wherein the corresponding integral of the bonding curve is approximately equal to the second amount in the request.

The distributed ledger may also be maintained by the server. For example, the server may be configured as a so-called miner. The server device is sometimes referred to as a miner, or mining device, or as a minter, or minting device. For example, server 160 may be configured to generate a new block for the distributed ledger; the new block including a selected set of transactions. The transactions may be selected by the server device from transactions that it received. Some amount of cryptographic tokens may be assigned to the miner for creating the block. For example, tokens may be a cryptocurrency. For example, the cryptocurrency may be associated with the distributed ledger. In particular, the second type crypto tokens may be associated to a particular distributed ledger, e.g., the cryptocurrency may be bitcoin, ether, or the like. This is not necessary, for example, the second type tokens may be associated with a different distributed ledger than used for the first type tokens, or with not distributed ledger at all.

Server device 160 may be configured to obtain a smart contract from a distributed ledger, e.g., a blockchain. The smart contract may implement a creation procedure to fulfill creation requests, an annulment procedure to fulfill annulment requests, and so on. Server 160 may be configured to execute the corresponding computer code in the smart contract. Instead of a smart contract, the procedures may be implemented in conventional software, e.g., in the so-called chain logic. The data maintained by the software may be written on the distributed ledger regardless of the origin of the software, e.g., smart contract or not. For example, a transaction showing the creation, annulment or transfer of a token may be put on the distributed ledger. An updated supply size may be put on the distributed ledger. An updated bonding curve may be put on the distributed ledger, etc.

For example, client device 110 may be configured to maintain a wallet. For example, the client device 110 may be configured to send a transaction request to server device 160, e.g., to transfer tokens of the first type, to create tokens of the first type or to annul tokens of the first type, etc. Typically, the first type tokens and/or second type tokens may be transferred to or from the wallet maintained by the client device.

Client device 110 may also send an update request to update the bonding curve. For example, it may be required that an update request is linked to a particular identity, e.g., signed by a particular private key.

A transaction when processed is typically reflected in a block on the distributed ledger. Server device 160 may also have access to a wallet, possibly by execution of a procedure of a smart contract.

Client device 110 may comprise a processor system 130, a storage 140, and a communication interface 150. Server device 160 may comprise a processor system 170, a storage 180, and a communication interface 190. Storage 140 and 180 may be electronic storage. The storage may comprise local storage, e.g., a local hard drive or electronic memory. Storage 140 and 180 may comprise non-local storage, e.g., cloud storage. In the latter case, storage 140 and 180 may comprise a storage interface to the non-local storage.

Server device 160 may have access to a database 162. Database 162 may comprise a copy of a distributed ledger, e.g., as far as is available to server device 160. Given the distributed nature of distributed ledgers it may happen that some other server device has more blocks in its copy of the distributed ledger, or that the last block or last few blocks are different. Such differences will be resolved in time due to the distributed trust system of distributed ledgers. Database 162 is preferably local, and may be used in creating new blocks, and in verifying or validating blocks of other server devices. Database 162 may also be located in the cloud.

Client device 110 and server device 160 may be part of a crypto token system, e.g., crypto token system 100. Client device 110 and server device 160 may communicate internally, with other systems, external storage, input devices, output devices, and/or one or more sensors over a computer network. The computer network may be an internet, an intranet, a LAN, a WLAN, etc. The computer network may be the Internet. The system comprises a connection interface which is arranged to communicate within the system or outside of the system as needed. For example, the connection interface may comprise a connector, e.g., a wired connector, e.g., an Ethernet connector, an optical connector, etc., or a wireless connector, e.g., an antenna, e.g., a Wi-Fi, 4G or 5G antenna.

The communication interface 150 may be used to send or receive digital data, e.g., transaction requests to create or annul cryptographic tokens; said procedure may be part of a smart contract. The communication interface 190 may be used to send or receive digital data, e.g., transaction requests to create, annul or transfer cryptographic tokens. The communication interface 190 may be used to communicate with other server devices, e.g., to distribute a new block of a blockchain, or to synchronize transaction requests.

The execution of devices 110 and 160 may be implemented in a processor system, e.g., one or more processor circuits, e.g., microprocessors, examples of which are shown herein. The processor system may comprise one or more GPUs and/or CPUs.

Devices 110 and 160 System 100 may comprise multiple processors, which may be distributed over separate locations. For example, devices 110 and 160 may use cloud computing.

The devices 110 and 160 may comprise functional units that may be functional units of the processor system. For example, the functional units shown may be wholly or partially implemented in computer instructions that are stored at the device, e.g., in an electronic memory of the device, and are executable by a microprocessor of the device. In hybrid embodiments, functional units are implemented partially in hardware, e.g., as coprocessors, e.g., cryptographic coprocessors, and partially in software stored and executed on the device.

FIG. 1C schematically shows an example of an embodiment of a cryptographic token system. System 100 comprises multiple client devices; shown are client device 110.1 and 110.2. System 100 comprises multiple server devices; shown are server device 160.1 and 160.2. The devices are connected through a computer network 172, e.g., the Internet. The client and server device may be according to an embodiment. The client devices may cooperate among each other to transfer cryptographic tokens of the first type. The client devices may interact with a server device to create, to annul, or transfer a cryptographic token of the first type, e.g., from a first wallet to a second wallet. A client device may request a server device to execute a creation procedure to create new tokens of a type of cryptocurrency, possibly in exchange for cryptographic tokens of the second kind, e.g., tokens of another type of cryptocurrency. A client device may request a server device to execute an annulment procedure to annul tokens of the first type of cryptocurrency, possibly in exchange for tokens of the second type of cryptocurrency. Creation is also sometimes referred to as a buying, while annulment is sometimes referred to as destroying or selling.

For example, any of the client devices may request creation or annulment of first type tokens. The request may include an amount of first type tokens that the requests relates to. In an embodiment, the request includes an amount of second type tokens instead. This provides a challenge to the servers as they need to obtain a corresponding amount of first type tokens that would result in the requested amount of second type tokens. For example, any one of the server device may fulfill the request, e.g., by performing the approximation algorithms, and including the transaction in a block. The block may include the first type token amount as with other transactions. When the block is verified or validated or otherwise verified, e.g., by one or more of the other servers, they do not need to execute the approximation algorithm, instead they can verify the transactions, as if the request was made including a first type token amount.

Storage may be implemented as an electronic memory, say a flash memory, or magnetic memory, say hard disk or the like. Storage may comprise multiple discrete memories together making up storage 140, 180. Storage may comprise a temporary memory, say a RAM. The storage may be cloud storage.

Typically, the client device 110 and server device 160 each comprise a microprocessor which executes appropriate software stored at the system; for example, that software may have been downloaded and/or stored in a corresponding memory, e.g., a volatile memory such as RAM or a non-volatile memory such as Flash. Alternatively, the systems may, in whole or in part, be implemented in programmable logic, e.g., as field-programmable gate array (FPGA). The systems may be implemented, in whole or in part, as a so-called application-specific integrated circuit (ASIC), e.g., an integrated circuit (IC) customized for their particular use. For example, the circuits may be implemented in CMOS, e.g., using a hardware description language such as Verilog, VHDL, etc. In particular, client device 110 and server device 160 may comprise circuits for the cryptographic processing, and/or arithmetic processing.

A processor circuit may be implemented in a distributed fashion, e.g., as multiple sub-processor circuits. A storage may be distributed over multiple distributed sub-storages. Part or all of the memory may be an electronic memory, magnetic memory, etc. For example, the storage may have volatile and a non-volatile part. Part of the storage may be read-only.

When fulfilling a creation request, e.g., by a server such as server 160, new cryptographic tokens of the first type are created. Said first type tokens can be transferred to a wallet, e.g., an address, e.g., of a client device, e.g., the device that made the creation request. In exchange, another type of cryptographic tokens, e.g., of a second type are transferred away from the client device. For example, the second type tokens may be transferred to a pool, e.g., a wallet or address that is under the control, or under partial control of server 160. When first type tokens are later annulled, e.g., destroyed, then second type tokens can be returned. The pool in which second type tokens are kept, e.g., a wallet, may be associated with the smart contract or other software that implements the creation and annulment procedures. The pool and the procedure associated with it, e.g., the creation, annulment, etc., procedures are sometimes referred to as the marked maker.

The relationship between the amount of first type tokens that are created or annulled and the amount of second type tokens that are taken or returned is defined by one or more bonding curves. There may be a single bonding curve, but preferably a creating bonding curve and an annulling bonding curve are used. The creation curve lies above the annulment curve, e.g., to make frontrunning attacks harder. Even if two bonding curves are used, they may still be derived from a single bonding curve, e.g., by adding or subtracting fee terms.

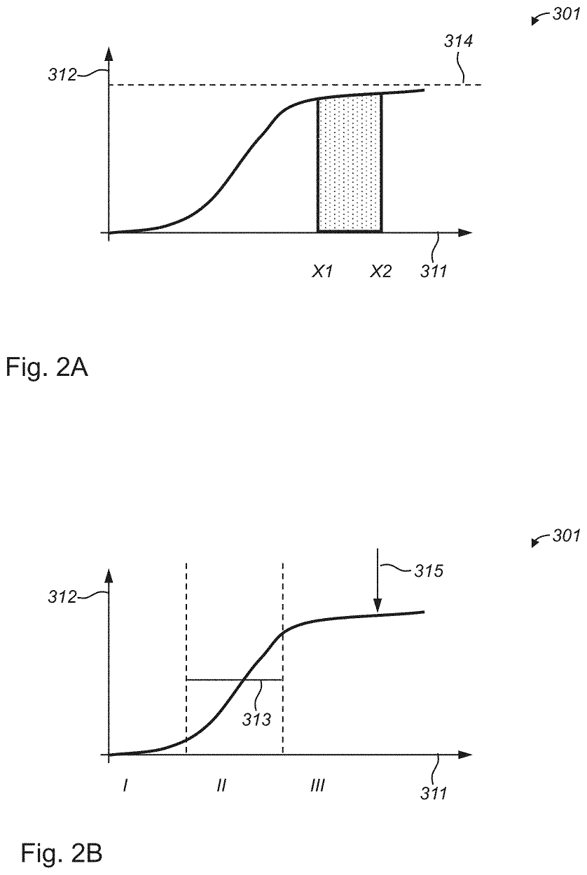

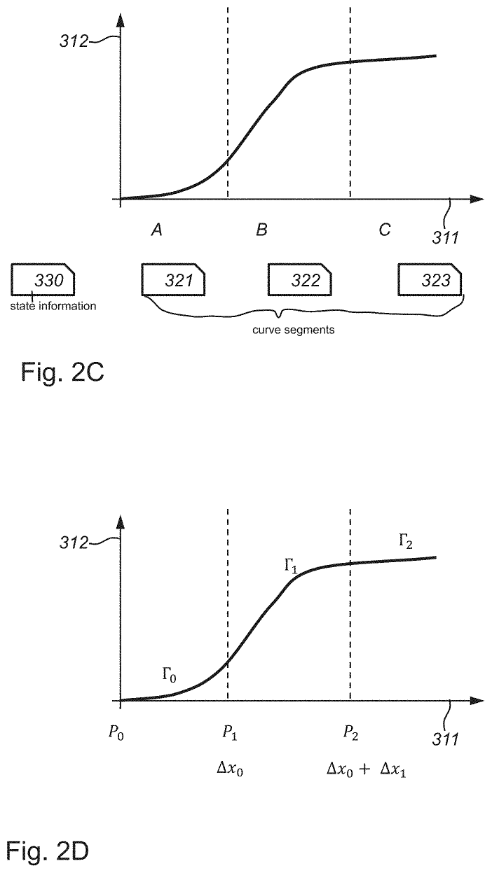

FIG. 2A schematically shows an example of an embodiment of a bonding curve 301. On the x-axis 311 is the amount of crypto tokens of the first type. On the y-axis 312 is the amount of crypto tokens of the second type.

A bonding curve may be regarded as function, typically, taking a single input and producing a single output; conceptually, the input is associated with first type tokens while the output are associated with second type tokens. Typically, a bonding curve is increasing or at least non-decreasing.

In case of creating tokens, this function may be referred to as the creating bonding curve. Suppose the supply of tokens of the first type is currently X1, and the first user wants to obtain (X2−X1) tokens, so that the new supply will become X2, e.g., execution of a creation procedure. To determine the amount of tokens of the second type that are to be exchanged, one integrates a function from X1 to X2.

Likewise, suppose the supply of tokens of the first type is currently X2, and the first user wants to annul (X2−X1) tokens of the first type, so that the new supply will become X1. To determine the amount of tokens of the second type that are to be received, one integrates a function from X1 to X2. In case of annulling tokens, this function may be referred to as the annulling function.

In an embodiment, a single bonding curve is used, though typically two bonding curves are used-one for creation requests, sometimes referred to as the creating bonding curve, and one for annulment requests, sometimes referred to as the annulling bonding curve. The creating bonding curve is higher than the annulment curve. This is sometimes referred to as the spread, or the buy-sell spread. A spread is useful for discouraging front running attacks.

Note that the exact amount of second type tokens that a creation request requires or that an annulment request will obtain is hard to predict. A client device could in principle compute the integral as well, but by the time the request is executed the current supply may have changed so that the previously computed amount of second type tokens is no longer correct. For example, in FIG. 2A, if point X1 is the current supply of first type tokens and X2 is the new supply of first type tokens, then the integral give the amount of second type tokens required for the creation transaction. But if points X1 changes, then the integral will have a different value, so that the amount of second type tokens may be higher or lower.

Likewise, for an annulment request; if X2 is the current first type token supply, and X1 is the new first type token supply after the annulment, then the integral represents the amount of second type tokens that are obtained by the annulment. Again, if points X1 and X2 differ by the time the transaction is actually executed, the exact amount of second type tokens differs.

A solution for this problem is to allow creation requests or annulment requests to specify a second type token amount instead of a first type token amount. A corresponding first type token amount can then be computed, e.g., by a server device, by computing a first amount of crypto tokens of the first type to be created in response to the creation request, or to be annulled in response to the annulment request.

A difficulty with this approach is that the integral may not be exactly computable, and even if it is, it will typically result in a function that is too complicated for easy analytic computation. Even if the bonding curve is a second degree polynomial, then the integral would be a degree three polynomial, which is not easily solvable; if they have a rational solution at all. In practice a bonding curve can be more complicated than a degree two polynomial. For example, the bonding curve shown in the background does not even have an explicit closed form formula representing the integral, e.g., an affine function, polynomial function, or the like.

These difficulties are addressed by executing an approximating algorithm for estimating the first amount. The first amount is approximated so that the appropriate integral equals the desired, that is the indicated second amount, to within a threshold. That is, in case of first type token creation, the integral over the creating bonding curve from the current supply size to the current supply size increased with the first amount approximates the indicated second amount, e.g., equals the indicated second amount to within a threshold.

The first amount may be computed as an amount of tokens, e.g., as (X2−X1) in FIG. 2A, but may also be computed as the current supply size increased with the first amount, e.g., as X2 in FIG. 2A.

It is convenient if the approximating algorithm is configured to under-estimate the first amount, this means that the creation request will not create a demand for more second type tokens than was indicated in the request. For example, the integral of the creating bonding curve from the current supply size to the current supply size increased with the first amount being not more than the indicated second amount. This is not necessary, and a certain amount of overshoot may be acceptable. For example, that such overshoot may occur may be known to users of the system. For example, an advantage of this approach is that the user can include a transfer to the indicated second type tokens in his creation request and be sure that the request will not be rejected for insufficient funds. That is assuming that other checks will work out, for example, the transferring second type tokens should be associated with the indicated wallet, etc.

For example, in an embodiment, a creation request comprises a transfer of second type tokens equal to the indicated amount of second type tokens or more than that amount. In an embodiment, a creation requests is required to transfer more than the indicated amount of second type tokens so that overshoot can more easily be accommodated. In either case, if less than the transferred amount of second type tokens were used, the surplus may be transferred back, e.g., bound to an address supplied in the creation request.

A convenient approximating algorithm comprises a binary search for the first amount. For example, a lower estimate of the first amount and an upper estimated may be maintained. For example, the lower estimate may initially be set at the current supply size. A mid-point between the lower estimate and the upper estimate can then be evaluated by computing the integral from the current supply to the mid-point. If the integral is lower than the indicated second amount, then the mid-point replaces the lower estimate, and the upper estimate otherwise. This process can be iterated until a lower estimate is found for which the second amount is sufficiently close to the indicated amount, e.g., within a threshold.

For example, a threshold may be a percentage, e.g., of the first amount, an absolute amount, or the like. A suitable threshold depends on the system. For example, a threshold may be 0.01, or 1% or the like. Hybrids are possible.

For example, the indicated second amount in a creation request may be transferred in full, and if there is a surfeit, e.g., if the recomputed second amount if less, possibly only slightly less, the surfeit can be refunded. This option is cryptographically easier, than the alternative, e.g., only transferring the recomputed amount, although not impossible.

Once the first amount has been determined, a creation request can be further processed. This may involve, for example, maintaining the supply size of first type tokens. In case of a creation request, increasing the current supply size with the first amount of crypto tokens of the first type. The first type crypto tokens may be created and transferred. For example, they may be bound to a wallet, e.g., an address of a client device. For example, an important part of the creation of a first type token may be the inclusion of data in a block on a distributed ledger indicating that the token is created and the address it is bound to.

Likewise, an amount of second type tokens may be transferred, e.g., away from the client device. This could be the indicated second amount. However, as the computation of the first amount may not be entirely exact, in an embodiment, one may recompute the second amount corresponding to the first amount. For example, the recomputed second amount may be obtained by computing the integral over the appropriate bonding curve for the computed first amount. The difference between the indicated second amount and the recomputed second amount is likewise small, but a more accurate transfer is preferable.

A system for maintaining crypto tokens of a first type may support annulment requests in a similar manner as creation requests; although this is not necessary. For example, a system might support indicating a second amount of second type tokens for a creation request, but not for an annulment request. However, in an embodiment, a system supports indicating a second amount of second type tokens both for creation requests and for annulment requests. Such a system might also support indicating creation and/or annulment request in first type tokens.

For example, in case of an annulment request, the estimation might be configured to over-estimate, so that at least the indicated second type tokens are released, though possibly somewhat more. In this case, the system may be configured to verify that the over-estimated amount of first type tokens that corresponds to the over-estimated second type tokens are actually available at the wallet, e.g., address, indicated in the annulment request.

For example, second type tokens may be transferred from a pool, which is under control of the system, e.g., which is associated with system software, e.g., a smart contract, chain software, and so on.

In case of annulling, maintaining the current supply may comprise decreasing the current supply size with the first amount of crypto tokens of the first type. The second amount of crypto tokens of the second type may be transferred from the pool to the address indicated in the annulment request.

A client device may maintain a first wallet for first type tokens. For example, first type tokens may be transferred here, e.g., deposited here, in case of a creation request. For example, tokens in associated with this wallet may be removed, e.g., invalidated, in case of an annulment request. A client device may maintain a second wallet for second type tokens. For example, second type tokens may be deposited here in case of an annulment request. For example, tokens in associated with this wallet may be transferred from this wallet in case of a creation request.

Creation requests may be executed by a creation procedure. Annulment requests may be executed by an annulment procedure.

These procedures may be implemented in software. The software may be chain software, e.g., running on server device. For example, a server device may be configured with such software, e.g., during an installation procedure. In an embodiment, the creation procedure and/or annulment procedure is implemented by a smart contract. For example, a server device may be configured to obtain a smart contract from a distributed ledger. The smart contract implements a creation procedure for processing a creation request and implements maintaining the current supply size, and/or an analogous annulment procedure.

Using a smart contract has the advantage that the software is visible for anybody who has access to the distributed ledger. This increases trust in the software. Moreover, the trust mechanisms in place for the distributed ledger, e.g., also enable trust in the authenticity of the smart contract. Furthermore, the distributed ledger mechanism may be used to allow updates to the smart contract under predetermined and visible conditions. For example, a governor of the system, may be able to update the software, possibly with support from a majority of the server device, or a majority stake, or the like.

Note that cryptocurrencies can be created with or without a smart contract. For example, cryptocurrency can be maintained by chain logic, e.g., software defining the distributed ledger. However, if the distributed ledger is configured for smart contracts, then a fair processing of the transactions becomes even more important. A potentially unlimited number of cryptocurrencies may be defined on such a distributed ledger.

Note also that transactions on a chain may relate to the transfer of a cryptocurrency, whether defined by a smart contract or not, but may also relate to other transaction. Distributed ledgers can be used to securely store all kinds of information.

Note that X1 and X2 may be integral numbers, but this is not necessary. Tokens may also be created and annulled in fractions of integer tokens. A new state written to the ledger may include that the new supply of tokens is X2.

For example, tokens of the first type may be a new type of token created according to an embodiment, e.g., to facilitate some new application that requires token management. This could range from shops, to games, to services, to dating applications. Tokens of the second type are typically existing tokens that can be transferred digitally. For example, the tokens of the second type may be bitcoin or ether, or the like. For example, tokens of the first type may be created to regulate access to a computing resource. A user may acquire such tokens and exchange them for the access to computing resource. On the other hand, if the user has no present use for the computing resource, he/she may return the first type tokens in return for second type tokens.

The bonding curve is typically only used when creating or annulling tokens with respect to the market maker. The tokens of the first type could be transferred on a secondary market as well, and in theory the tokens may be exchanged for whatever the parties agree to. However, as both parties also have the option to obtain tokens from the market maker, or to have them annulled by the market maker, the bonding curve will have a strong influence on the secondary market. One motivation to use bonding curves is to avoid large price fluctuations.

The bonding curve may have an S-shape, or sigmoidal shape, e.g., as shown in FIG. 2A. When supply on the x-axis is low, the tokens can be obtained easily. When the market is mature, the price typically converges to a value 314. This is not needed, though. Instead, of convergence, e.g., the price increase may be much flatter than in a middle part of FIG. 2A. A sigmoidal shape is not necessary though. For example, a bonding curve may have a bend-up shape.

In an embodiment, the bonding curve that is integrated, e.g., the creating bonding curve or the annulling bonding curve, can be represented as a sum of terms. The first term may be a universal bonding curve that applies both to creation and to annulment.

Typically, the bonding curve term is the major term, e.g., larger than the other terms. For example, the creating bonding curve may be equal to the universal bonding curve plus a positive fee, while the annulling bonding curve may be equal to the universal bonding curve plus a negative fee.

In known systems, the bonding curve is the only term, this would work in the sense that tokens of the first or second types can reliably be exchanged for tokens of the second of first type, but these systems are vulnerable to an attack known as front-running.

If an attacker can influence the order in which orders are processed, or the order in which his order is processed relative to other orders, he/she can artificially ensure that the order receives a favorable treatment.

To mitigate this risk, the function that is integrated can include, in addition to the bonding curve a fee term. The fee term makes front running less favorable, or even unfavorable.

In an embodiment, the fee term comprises a multiple of the bonding curve shifted over an amount of crypto tokens of the first type, e.g., s_{fr}. For example, if the bonding curve is Γ(x), then the shifted bonding curve may be Γ(x+s_{fr}) or Γ(x−s_{fr}). The fee term may also comprise the bonding curve Γ(x) itself. For example, fee terms may be a difference of such terms or a multiple thereof. That is, a positive fee term may be of the form γ(Γ(x+s_{fr})−Γ(x)), in which γ is a number, e.g., a real number, e.g., a number between 0 and 1, e.g., 0.5, or the like. The difference dl=Γ(x+s_{fr})−Γ(x) may also be weighted in other ways, e.g., with an exponent, dl^{γ}, or in a polynomial, P(dl) and so on. The difference term dl is representative for the flatness of the binding curve around x. For example, the creating bonding curve may be Γ(x)+γdl. For example, the annulling bonding curve may be Γ(x)−γdl.

An advantage of including a term like γ(Γ(x+s_{fr})−Γ(x)) in a fee term, is that the fee term is small if the supply size is large.

That is, if the system is mature and the bonding curve is quite flat, then only small gains can be made with frontrunning, but if the system is not yet mature and the bonding curve is steep then the fee is large and frontrunning is correspondingly less favorable.

In an embodiment, the creating bonding curve or an annulling bonding curve is derived from a bonding curve as a linear combination of one or more of the bonding curve (Γ(x)), a shifted bonding curve (Γ(x+s_{fr}); Γ(x−s_{fr})) and an optional constant. There may be multiple shifts, e.g., a linear combination of Γ(x), Γ(x+s₁), Γ(x+s₂) and 1.

For completeness, FIG. 2B schematically shows an example of an embodiment of a bonding curve as may be used when the market is in its infancy. Shown are three phases, sometimes called regimes. In a first regime I, tokens of the first type are created. Although the bonding curve indicates that tokens of the second type should be exchanged for them, to fill a pool this is not done in regime I. For example, these tokens may be used as an incentive for early investors, inventors, and the like. In a second phase, or regime II, tokens of the first type are exchanged for tokens of the second type. However, instead of the price indicated by the bonding curve, a constant price 313 is used. The price is chosen such that at the end of regime II, the size of the pool (in tokens of the second type) is as large as the integral of the bonding curve up to the end of regime II. Regime II may for example, be used to start-up the system. For example, early investors may perform this task. In regime III, the prices follow the bonding curve as indicated above. Should the supply drop from regime III into the part of the curve for regime II or I, then the normal prices as indicated by the bonding curve are used. Various refinements are possible. For example, the system may refuse to annul tokens if that would cause the supply to drop between a certain amount. Two bonding curves may be used, etc.

In an embodiment, the market maker, e.g., in a state on the distributed ledger maintains a current supply of first type tokens. For example, FIG. 2B shows at 315 the current supply of tokens. If first type tokens are created, the amount of second type tokens needed for it is obtained by integrating the curve starting from point 315 to the right; that is toward higher supply as tokens are created. If first type tokens are annulled, the amount of second type tokens offered in return is obtained by integrating the curve starting from point 315 to the left; that is toward lower supply as tokens are destroyed.

A bonding curve may be defined by parameters. This has advantages, as it reduces the amount of data that needs to be stored, e.g., on the distributed ledger, e.g., in the smart contract or with an update of the bonding curve. A bonding curve may also be defined off-chain, e.g., in chain logic. Preferably, the integral of the bonding curve can be expressed in terms of the parameters, e.g., as a function taking the parameters as input. This reduces the amount of on-chain computation. For example, a bonding curve may be defined as one or more splines, line segments, polynomials, polynomial segments.

In an embodiment, the bonding curve is defined by multiple curve segments. The multiple segments are concatenated and together define the bonding curve. This has the advantage that different equations can be used for the different curve segments. If one function were used to define the entire curve, then this would be a complicated function to accommodate the desired shape of the curve. Such a complicated function is hard to integrate. On the other hand, when segments are used, one would integrate along the segment or segments that defines that part of the bonding curve. The segments are easier to define, and preferably have a closed form primitive.

FIG. 2C schematically shows an example of an embodiment of a bonding curve. Shown in FIG. 2C are three curve segments: segments A, B and C. Using curve segments are a convenient way to encode a bonding curve in a smart contract and the like.

In each curve segment the bonding curve is defined by one or more parameters. For example, parameters 321 define segment A, parameters 322 define segment B, and parameters 323 define segment C. The parameters 321-323 may be included in the state, especially if the bonding curve is updatable. Also shown in FIG. 2C is supply 330, that is the amount of tokens of the first type that are currently in existing, e.g., the sum of successful creation requests minus the sum of successful annulment requests.

A convenient way to define the curve segments is to use polynomials. The parameters 321-323 may comprise the coefficients of the polynomials. The exponents in polynomials are integral. The curves may be defined by so-called generalized polynomials, e.g., sums of the terms of the form ax^{b}, wherein b may be non-integer, though, typically, rational. Generalized polynomials share with regular polynomials, that they can be integrated easily and in closed form. Polynomials can be conveniently expressed in the form of Bezier splines.

In experiments, it was found that using three curve segments and polynomials of degree 3 (cubic polynomials) worked well; a bonding curve can be defined with fewer, e.g., 2 curve segments, or with more than 3 curve segments. The polynomials degree can be varied as well.

It is possible that the segments, e.g., segment A, B, and C, follow the same division as the regimes I, II and III, but this is not necessary. On the contrary, it was found that flexibility in choosing where segments start and end can allow a better fit. For example, segment A can be larger than regime I, while segment B, may be smaller than regime II. Regime III may start before segment C. Where the best points for starting and ending segments may depend on the fitting of the curves.

A fee term may also be expressed as a function, which may be defined similarly, e.g., using one or more curve segments defined by parameters, e.g., polynomial parameters. An advantage of expressing the fee term in terms of the bonding curve, e.g., as a linear combination of shift(s) of the bonding curve, is that no new set of parameters is needed, except possibly for the amount of shift. The shift may be predetermined, e.g., hard coded, e.g., part of the chain logic. The shift may be configurable, e.g., part of a state saved on the blockchain. This shift may be dynamic, e.g., determined from past transactions, e.g., past transaction as visible on the ledger.

For example, in an embodiment, the system is configured to execute an approximating algorithm for estimating a first amount wherein an integral of a creating bonding curve from the current supply size to the current supply size increased with the first amount equals the indicated second amount to within a threshold, while the creating bonding curve is defined as a sequence of multiple curve segments, a curve segment connecting to a subsequent curve segment. The same holds for an annulling bonding curve, except that the integral is computed from the current supply size decreased with the first amount to the current supply size.

Integrating over a bonding curve that is defined by multiple segments has several advantages. First of all the integrals over the individual segments can be precomputed, thus saving on computation. This also makes the approximation, at least over the segment exact. The functions defining a segment can be less complicated, as they have to approximate only on a smaller domain. Accordingly, their integrals can also be less complicated, which in turn means fewer parameters in their definitions and/or easier or even exact approximations.

For example, one could approximate a bonding curve by many linear segments, which have a quadratic integral which in turn can be solved for analytically.

For example, if a bonding curve on a segment is defined by parameters, e.g., in case of a polynomial, generalized polynomial and the like, the integral can also be expressed using said parameters. The approximation algorithm thus does not need to repeatedly compute or estimate an integral, but can use the closed form integral expression in terms of the parameters.

For example, a particular versatile way to define bonding curves, e.g., on segments, is to use polynomials, e.g., Bezier splines.

For example, an approximation algorithm for computing the first amount of crypto tokens, may comprise
computing the integral from the current supply size to the end of a first curve segment associated with the current supply size,

If the integral is smaller than the indicated second amount,
adding precomputed integrals of a number of curve segments following the first curve segment until adding a next curve segment would exceed the second amount,
executing the approximating algorithm on the next curve segment.

In this way, one can quickly find the segment where the X2 point should lie, and the approximation algorithm, e.g., a binary search can be used there.

Advantageously, a Newton approximation is used for the approximation algorithm. This works well since the Newton method uses the derivative of the function under approximation. In this case, however, the function being integrated is defined as an integral, so that derivative function is known. For example, the derivative function can be expressed in parameters.

FIG. 2D schematically shows an example of an embodiment of a bonding curve. The bonding curve shown in FIG. 2D is defined as a sequence of curve segments. Shown are three segments: Γ₀, Γ₁, and Γ₂. There could be two segments, or more than three segments. The y-coordinate of the beginning point of each segment is denoted P₀, P₁ and P₂. Note that Pᵢ indicates an amount of second type tokens, even though they are shown on the x-axis in FIG. 2D. The increases of the corresponding x-coordinates are denoted Δx₀ and Δx₁. Note that the x-coordinate corresponding to P₀ is zero.

In an embodiment, the curve segments are defined by polynomials, e.g., a polynomial mapping an x-coordinate to a y-coordinate. It is convenient to write the polynomials as a Bézier curve. An advantageous choice turns out to be cubic Bézier curves. To fit a cubic Bézier curve through consecutive points Pᵢ, one may use the following formula. The values aᵢ and bᵢ are auxiliary to fit the curve.

Γᵢ(t)=(1−t)³·Pᵢ+3t(1−t)²·aᵢ+3t²(1−t)·bᵢ+t·Pᵢ₊₁

To fit the curves various further conditions may be imposed. For example, one may require continuous first and second derivative at the connecting points. Taking into account that the derivative is for t we may have:

$${Γ}_{i - 1}^{′} ( t = 1 ) \frac{Δ {x}_{i}}{Δ {x}_{i - 1}} = {Γ}_{i}^{′} ( t = 0 ) \\ {Γ}_{i - 1}^{″} ( t = 1 ) \frac{Δ {x}_{i}}{Δ {x}_{i - 1}} = {Γ}_{i}^{″} ( t = 0 )$$

Accordingly, we have

Γ′ᵢ(t)=3[−(1−t)²·Pᵢ+(1−3t)(1−t)·aᵢ+t(2−3t)·bᵢ+t²·Pᵢ₊₁]

and

Γ″ᵢ(t)=6[(1−t)·Pᵢ+(3t−2)·aᵢ+(1−3t)·bᵢ+t·Pᵢ₊₁]

At the connection points this means:

Γ′ᵢj(t=0)=3(−Pᵢ+αᵢ)

Γ′ᵢ(t=1)=3(−bᵢ+Pᵢ₊₁)

Γ″ᵢ(t=0)=6(Pᵢ−2aᵢ+bᵢ)

Γ″ᵢ(t=1)=6(aᵢ−2·bᵢ+Pᵢ₊₁)

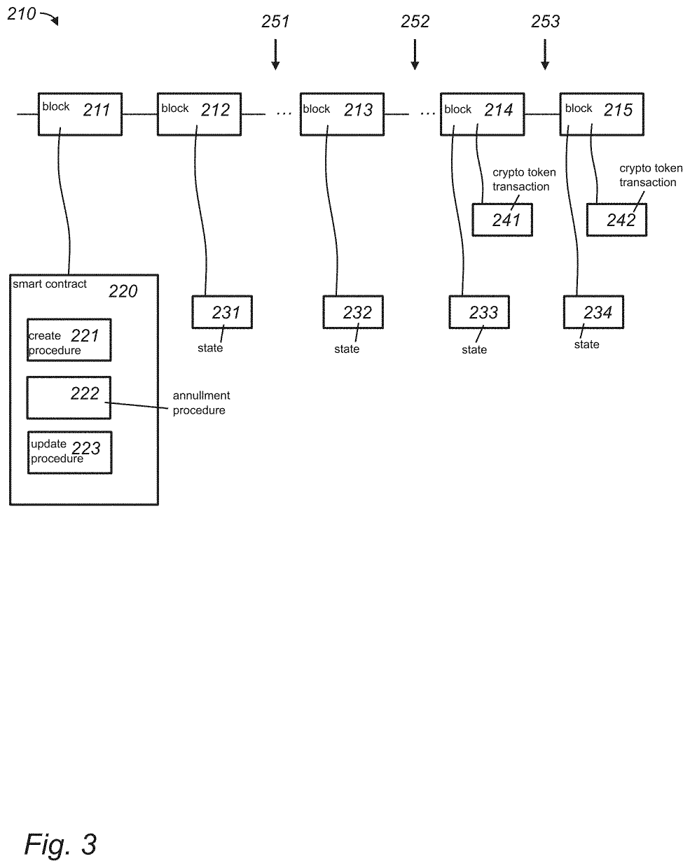

FIG. 3 schematically shows an example of an embodiment of a blockchain 210. Blockchains are particular example of distributed ledgers that has shown to work well in embodiments. Other examples of distributed ledgers can also be used. For example, in an embodiment the distributed ledger may be a hash graph, a tangle or a lattice. The distributed ledger comprises multiple blocks, which are linked to each other. The blocks may comprise transactional data and metadata. The metadata may comprise linking information and a consensus mechanism. Embodiments are primarily described with reference to a blockchain, but such an embodiment could be changed to use another type of distributed ledger, in particular a graph based one.

Blockchain 210 comprises multiple blocks, which are linked to each other in a sequence. For example, the linkage may comprise a consensus mechanism. For example, such a mechanism may be a proof of work, e.g., as in Bitcoin. The mechanism may be a proof of stake. A consensus mechanism allows distributed trust in the distributed ledger. Other consensus mechanism, e.g., as known in the art may be used in an embodiment.

To aid the discussion, FIG. 3 shows three points in the blockchain: points 251, 252, and 253, corresponding to three moments in time. At point 251, blocks up to block 213 have been created, but not yet block 213. At point 252, blocks up to block 214 have been created, but not yet block 214. At point 253, blocks up to block 215 have been created, but not yet block 215.

Show in blockchain 210 are multiple blocks, in this case, 5 blocks: blocks 211, 212, 213, 214, and 215. There may be more or fewer blocks. A block may comprise data related to the distributed ledger mechanism, e.g., consensus data, but also other information. In particular a block may comprise transactions, in which tokens are bound to an address, e.g., related to the public key of a client, e.g., as incorporated in a client device. Blocks may also include other information.

A block in the distributed ledger is created by a miner who has capability to create the consensus information, whether it is proof of stake or proof of work or the like. Typically, a miner, e.g., a server device, receives multiple transactions, e.g., directly from user or from other miners that share transactions they received with each other. From the received transactions a selection is made, which in turn is included in the new block of the distributed blockchain. A part of the total amount of cryptocurrency tokens that is associated with the new block, e.g., tokens minted by the creation of the block itself, and the transaction fees associated with the included transactions, may be transferred to the miner, e.g., in the very block just mined.

The distributed ledger may implement a cryptocurrency. For example, the creation of new blocks may also create new crypto tokens of the cryptocurrency. The miners typically receive all or part of the newly minted cryptocurrency. The crypto tokens are linked to a particular cryptographic identity, e.g., address or cryptographic key.

Interestingly, once a distributed ledger exists further cryptographic currencies can be created using it, e.g., by using a smart contract. For example, a block in the distributed ledger may comprise a smart contract. Block 211 shows an example, in the form of a smart contract 220. A smart contract is typically written in a computer language. An example of a computer language that is optimized for smart contracts is solidity. For example, in an embodiment blockchain 210 may be the Ethereum blockchain, and the smart contract may be written in solidity. It is not required to restrict to a particular language or blockchain though. For example, the Ethereum blockchain may be used as described in the paper “Ethereum: a secure decentralised generalised transaction ledger,” by G. Wood, e.g., the Istanbul version 80085f7 of 2021 Jul. 11.

For example, in an embodiment, a server configured to maintain crypto tokens of a first type may be configured to obtain the smart contract from the distributed ledger. For example, the smart contract may be stored in a block of the distributed ledger. The smart contract may implement the needed procedures, e.g., a creation procedure for creating the crypto tokens of the first type and an annulment procedure for the annulment of crypto tokens of the first type. The smart contract may also implement an update procedure. The smart contract may be configured to maintain the current supply size. The smart contract may define a bonding curve.

In an embodiment, blockchain 210 is used to create and annul cryptographic tokens of a first type. Colloquially, creating new cryptographic tokens is sometimes referred to a ‘buying’ the tokens; annulling a cryptographic token is sometimes referred to as ‘selling’ the tokens.

The smart contract implements multiple procedures, including at least a create procedure 221 and an annulment 222 (also called a sell procedure). Optionally, the contract may implement an update procedure 223. Colloquially, the create procedure is also called a buy procedure and the annulment procedure 222 a sell procedure.

This is not entirely accurate as typically the tokens no longer exist once they are annulled. The total supply of tokens decreases after an annulment action. The annulment procedure is also referred to as a destroy procedure.

The server executes the create procedure and as a result obtains a new state. For example, the new state may reflect the increased number of crypto tokens of the first type that are now in existence (referred to as the supply). The server may also obtain a transaction that indicates that the new cryptographic tokens are transferred to the first user, and/or a transaction that indicates that the existing cryptographic tokens of the second type are transferred from the first user to a wallet associated with the smart contract. The smart contract is an example of a market maker. An amount of second type tokens may be kept in reserve by the market maker, e.g., in wallet. This part of the wallet is referred to as the pool or pool balance. The same wallet may be used to hold tokens not part of the pool. One may also reserve use of this wallet for only the pool.

The server client writes on the blockchain, e.g., includes in a block, the new state, and the new crypto tokens of the first type, the transferred crypto tokens of the second type are written on this or another blockchain. Tokens of the first type and the state may be put on separate blockchains as well.

Suppose a first user wants to buy a number of crypto tokens of a first type. He/she sends a request through a client device to a server device. The request may be sent to multiple server devices. The request may include, e.g.,
the amount y of crypto tokens of a second type reserved for buying first type crypto tokens.
an address to bind the crypto tokens of a first type to.

For example, consider that the request is sent at point 252, just before block 214 is created.

The server device retrieves the smart contract 220 from the blockchain. The smart contract uses a state which may be updated. The server device retrieves the current state from the blockchain. Blockchain 210 shows states 231 and 232 before point 252, so that the server device retrieves state 232.

To determine the amount of cryptographic tokens of the first type (x) that are exchanged for an amount of cryptographic tokens of the second type (y), colloquially referred to as the price, the smart contract uses a bonding curve.

For example, the server device may estimate a value x, such that the integral over the bonding curve from s to s+x equals y, usually within a threshold. For example, the integral may be more than y−ε but less than y. Here y is the indicated amount of second type tokens.

The smart contract may comprise a definition of the bonding curve. The definition of the bonding curve may also be in a state. The definition of the bonding curve may be the smart contract, until a new definition in a written state overrides it.

Note that a bonding curve is typically increasing or at least is non-decreasing. If multiple bonding curves are used, then for this creation request, a creating bonding curve would be used.

In an embodiment, the smart contract is not stored in a block but is accessible to the server through other means; for example, the smart contract may be obtained before executing said procedures. Using a smart contract may have the advantage that a proof of execution, e.g., of any particular procedure, can be placed on the distributed ledger. Note that even if a smart contract is not placed on the chain, it can still be executed as one, provided other miners have access to its code.

In fact, the procedures need not even be implemented in a smart contract but may be implemented in conventional software. For example, such software may be obtained by the server before execution. The software may be part of the chain logic software that defined the mining operation.

In an embodiment, the market maker, e.g., the smart contract or other software, could be part of the chain-application layer. A user may call the procedures like in a smart contract.

If no smart contract is used, the wallet or pool associated with the smart contract may be replaced with a wallet or pool associated with the market maker, e.g., with the software that implements the cryptocurrency.

Accordingly, the create procedure 221 in smart contract 220 may be configured to
Estimate the value x, so that integrating the creating bonding curve from the current supply to the current supply+x gives the required amount of crypto tokens of the second type. Note that the estimation itself can be done off-chain.
Transfer the crypto tokens of the second type to a pool associated with the smart contract. This may be the outcome of the above integral rather than the indicated second amount.
Increases the current supply with x, and bind x crypto tokens of the first type to the address.

Accordingly, block 214 may comprise a new state 233, e.g., comprising the new supply, and transaction(s) 241.

An annulment procedure may work in reverse. For example, an annulling request may be implemented by annulment procedure 222 as follows:
Estimate a value x, such that the integral of the annulling bonding curve from the current supply−x to the current supply obtains the required amount of crypto tokens of the second type
Transfers the crypto tokens of the second type from the pool associated with the smart contract to an address associated with the user. Instead, the recomputed second amount may be used.
Mark as invalid the x crypto tokens of the first type for the user.
Decrease the current supply with x

For example, if the annulment request is received at point 253, then block 215 may comprise a new state 234, e.g., comprising the new supply, and transaction(s) 242. If no smart contract is used, the pool may be associated with the market maker.

The result of the create or annulment procedure may be one or two transactions for the tokens of the first and second type respectively, and a new state. These three items may be written on a blockchain, such as the blockchain 210.

Both the create and annulment procedure may refuse to perform the create or annulment task if preconditions are not met. For example, the amount of crypto tokens of the first type available for an annulment request should be large enough, e.g., at least as large as the approximation. For example, the amount of crypto tokens of the second type available in the pool for an annulment request should be large enough.

Update procedure 223 may be called to change the shape of the bonding curve. Examples of update procedure 223 are given herein. An embodiment of a computer-implemented method for maintaining crypto tokens of a first type on a distributed ledger, may comprise creating crypto tokens of the first type in exchange for crypto tokens of the second type and annulling crypto tokens of the first type in exchange for crypto tokens of the second type, maintaining a current supply size on the distributed ledger indicating a current number of crypto tokens of the first type. The creating, annulling, etc., may be defined in chain logic, or may be defined in a smart contract, e.g., stored in a block of the distributed ledger. The amount of crypto tokens of the second type for the exchange may be computed by integrating a function from the current supply size to a new supply size. The method supports computing the amount of crypto tokens of the first type that are obtained for an indicated amount of tokens of the second type, by solving the above integral for the first amount.

The bonding curve may be a universal bonding curve or derived therefrom, e.g., a bonding curve and a fee term. For example, for creation, e.g., as defined in a creation procedure, the server device may, transfer an amount of crypto tokens of the second type to a pool, and transferring the amount of crypto tokens of the first type, e.g., to a wallet, and increase the current supply size with the amount of crypto tokens of the first type. For example, for annulling, e.g., as defined in an annulment procedure, the server device may transfer the amount of crypto tokens of the second type from a pool, and invalidate the amount of crypto tokens of the first type, and decrease the current supply size with the amount of crypto tokens of the first type, and invalidating the amount of crypto tokens of the first type.

In an embodiment, a bonding curve can be updated, e.g., the universal bonding curve and/or the creation and/or annulling bonding curves. There can be several reasons why a bonding curve may need to be changed after the smart contract has been defined.

A typical reason is that the amount of crypto tokens of the second type in the pool changed, and is not equal to the amount of crypto tokens indicated by the integral of the bonding curve.

For example, a pool may contain a higher amount of tokens than needed to cover for a possible first type token annulment, e.g., through accrual of fees.

For example, software, e.g., chain software or a smart contract may comprise an update procedure, which may be triggered. For example, it may be triggered by a governor of the system, e.g., as authenticated by one or more signatures. For example, it may be triggered automatically if certain conditions arise. For example, it may be triggered by the server devices, e.g., by a majority thereof.

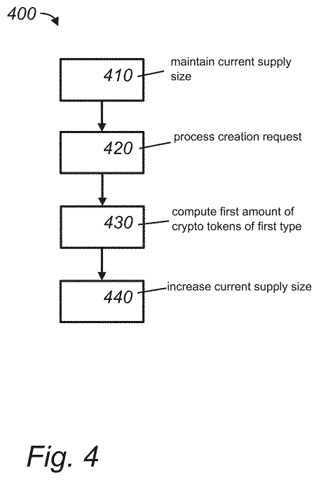

FIG. 4 schematically shows an example of an embodiment of a method 400 for maintaining crypto tokens of a first type. Method 500 is computer-implemented and comprises: A computer-implemented method (400) for maintaining crypto tokens of a first type comprising
maintaining (410) a current supply size indicating the number of crypto tokens of a first type,
processing (420) a creation request for creating crypto tokens of the first type in exchange for an indicated second amount of crypto tokens of a second kind according to a creating bonding curve, the indicated second amount being indicated with the creation request,
computing (430) a first amount of crypto tokens of the first type to be created in response to the creation request by executing an approximating algorithm for estimating the first amount wherein an integral of the creating bonding curve from the current supply size to the current supply size increased with the first amount equals the indicated second amount to within a threshold, processing the creation request further comprising
increasing (440) the current supply size with the first amount of crypto tokens of the first type, and transferring the first amount of crypto tokens of the first type.

Optionally, the method may comprise, obtaining a smart contract from a distributed ledger, the smart contract implementing a creation procedure for creating crypto tokens of the first type in exchange for crypto tokens of the second type and an annulling procedure for annulling crypto tokens of the first type in exchange for crypto tokens of the second type, the smart contract maintaining a current supply size indicating a current number of crypto tokens of the first type and a bonding curve defining a function. Obtaining a smart contract is optional as the creation procedure and annulment procedure may be implemented in other software as well.

For example, the method may be a computer implemented method. For example, obtaining the smart contract from a distributed ledger may comprise retrieving a block from a distributed ledger, e.g., over a computer network, or in a local database. Executing the smart contract may be done on a microprocessor. For example, the smart contract may be written in an interpretive language, which may be executed by an interpreter, a virtual machine, or the like. Integrating a curve may comprise executing computations, e.g., inserting a current supply and a new supply in a primitive, or antiderivative, of a bonding curve, a closed form integrant. Note that computing the first amount of first type tokens need not be done on chain. This can be a private computation, of which only the outcome is used. This is advantageous as computations on chain are slow and expensive, whereas private computation can use the full power of the computer. The outcome of the computation, e.g., the first amount of first type tokens that are to be created or annulled can be used as in a regular transaction.

Receiving a creation or annulment request may be over a computer network. Transferring first type tokens or second type tokens may comprise writing the transfer in a block for inclusion in a block of the distributed ledger. The block may comprise a consensus mechanism, e.g., a proof of work, or proof of stake.

Many different ways of executing the methods are possible, as will be apparent to a person skilled in the art. For example, the order of the steps can be performed in the shown order, but the order of the steps can be varied or some steps may be executed in parallel. Moreover, in between steps other method steps may be inserted. The inserted steps may represent refinements of the method such as described herein, or may be unrelated to the method. For example, some steps may be executed, at least partially, in parallel. Moreover, a given step may not have finished completely before a next step is started.

Embodiments of the method may be executed using software, which comprises instructions for causing a processor system to perform method 400. Software may only include those steps taken by a particular sub-entity of the system. The software may be stored in a suitable storage medium, such as a hard disk, a floppy, a memory, an optical disc, etc. The software may be sent as a signal along a wire, or wireless, or using a data network, e.g., the Internet. The software may be made available for download and/or for remote usage on a server. Embodiments of the method may be executed using a bitstream arranged to configure programmable logic, e.g., a field-programmable gate array (FPGA), to perform the method.

It will be appreciated that the presently disclosed subject matter also extends to computer programs, particularly computer programs on or in a carrier, adapted for putting the presently disclosed subject matter into practice. The program may be in the form of source code, object code, a code intermediate source, and object code such as partially compiled form, or in any other form suitable for use in the implementation of an embodiment of the method. An embodiment relating to a computer program product comprises computer executable instructions corresponding to each of the processing steps of at least one of the methods set forth. These instructions may be subdivided into subroutines and/or be stored in one or more files that may be linked statically or dynamically. Another embodiment relating to a computer program product comprises computer executable instructions corresponding to each of the devices, units and/or parts of at least one of the systems and/or products set forth.

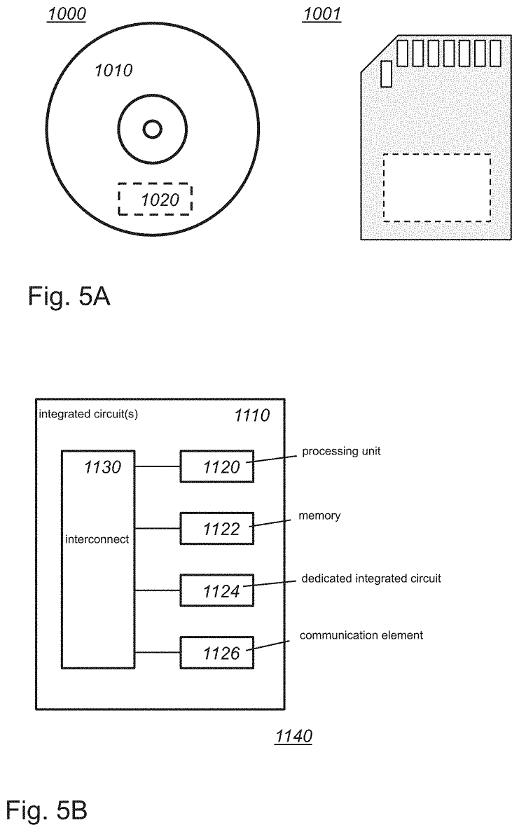

FIG. 5A shows a computer readable medium 1000 having a writable part 1010, and a computer readable medium 1001 also having a writable part. Computer readable medium 1000 is shown in the form of an optically readable medium. Computer readable medium 1001 is shown in the form of an electronic memory, in this case a memory card. Computer readable medium 1000 and 1001 may store data 1020 wherein the data may indicate instructions, which when executed by a processor system, cause a processor system to perform an embodiment of a method of maintaining a crypto token, according to an embodiment. The computer program 1020 may be embodied on the computer readable medium 1000 as physical marks or by magnetization of the computer readable medium 1000. However, any other suitable embodiment is conceivable as well. Furthermore, it will be appreciated that, although the computer readable medium 1000 is shown here as an optical disc, the computer readable medium 1000 may be any suitable computer readable medium, such as a hard disk, solid state memory, flash memory, etc., and may be non-recordable or recordable. The computer program 1020 comprises instructions for causing a processor system to perform said method.

FIG. 5B shows in a schematic representation of a processor system 1140 according to an embodiment of a device for maintaining a crypto token. The processor system comprises one or more integrated circuits 1110. The architecture of the one or more integrated circuits 1110 is schematically shown in FIG. 5B. Circuit 1110 comprises a processing unit 1120, e.g., a CPU, for running computer program components to execute a method according to an embodiment and/or implement its modules or units. Circuit 1110 comprises a memory 1122 for storing programming code, data, etc. Part of memory 1122 may be read-only. Circuit 1110 may comprise a communication element 1126, e.g., an antenna, connectors or both, and the like. Circuit 1110 may comprise a dedicated integrated circuit 1124 for performing part or all of the processing defined in the method. Processor 1120, memory 1122, dedicated IC 1124 and communication element 1126 may be connected to each other via an interconnect 1130, say a bus. The processor system 1110 may be arranged for contact and/or contact-less communication, using an antenna and/or connectors, respectively.

For example, in an embodiment, processor system 1140, e.g., a device for maintaining a crypto token may comprise a processor circuit and a memory circuit, the processor being arranged to execute software stored in the memory circuit. For example, the processor circuit may be an Intel Core i7 processor, ARM Cortex-R8, etc. In an embodiment, the processor circuit may be ARM Cortex M0. The memory circuit may be an ROM circuit, or a non-volatile memory, e.g., a flash memory. The memory circuit may be a volatile memory, e.g., an SRAM memory. In the latter case, the device may comprise a non-volatile software interface, e.g., a hard drive, a network interface, etc., arranged for providing the software.

It should be noted that the above-mentioned embodiments illustrate rather than limit the presently disclosed subject matter, and that those skilled in the art will be able to design many alternative embodiments.

Herein, use of the verb ‘comprise’ and its conjugations does not exclude the presence of elements or steps other than those stated. The article ‘a’ or ‘an’ preceding an element does not exclude the presence of a plurality of such elements. Expressions such as “at least one of” when preceding a list of elements represent a selection of all or of any subset of elements from the list. For example, the expression, “at least one of A, B, and C” should be understood as including only A, only B, only C, both A and B, both A and C, both B and C, or all of A, B, and C. The present invention may be implemented by hardware comprising several distinct elements, and by a suitably programmed computer. In an embodiment of the device enumerating several parts, several of these parts may be embodied by one and the same item of hardware. The mere fact that certain measures are recited in mutually separate embodiments does not indicate that a combination of these measures cannot be used to advantage.

What is claimed is:

1. A computer-implemented method for maintaining crypto tokens of a first type, comprising:
maintaining a current supply size indicating the number of crypto tokens of a first type;
processing a creation request for creating crypto tokens of the first type in exchange for an indicated second amount of crypto tokens of a second type according to a creating bonding curve, the indicated second amount being indicated with the creation request;
computing a first amount of crypto tokens of the first type to be created in response to the creation request by executing an approximating algorithm for estimating the first amount wherein an integral of the creating bonding curve from the current supply size to the current supply size increased with the first amount equals the indicated second amount to within a threshold;
wherein processing the creation request further includes increasing the current supply size with the first amount of crypto tokens of the first type, and transferring the first amount of crypto tokens of the first type.

2. The method for maintaining crypto tokens as recited in claim 1, wherein the approximating algorithm is configured to under-estimate the first amount, the integral of the creating bonding curve from the current supply size to the current supply size increased with the first amount being not more than the indicated second amount.

3. The method for maintaining crypto tokens as recited in claim 1, wherein the approximating algorithm includes a binary search for the first amount.

4. The method for maintaining crypto tokens as recited in claim 1, further comprising transferring the second amount of crypto tokens of the second type to a pool.

5. The method for maintaining crypto tokens as recited in claim 1, further comprising:
obtaining a smart contract from a distributed ledger, the smart contract implementing a creation function for processing the creation request and implementing the maintaining of the current supply size.

6. The method for maintaining crypto tokens as recited in claim 1, further comprising:
processing an annulment request for annulling crypto tokens of the first type in exchange for an indicated second amount of crypto tokens of a second type according to an annulling bonding curve, the indicated second amount being indicated with the annulling request;
computing a first amount of crypto tokens of the first type to be annulled in response to the annulling request by executing an approximating algorithm for estimating the first amount, wherein an integral of the annulling bonding curve from the current supply size decreased with the first amount to the current supply size equals the indicated second amount to within a threshold;
wherein the processing of the annulling request further includes decreasing the current supply size with the first amount of crypto tokens of the first type, and transferring the second amount of crypto tokens of the second type.

7. The method for maintaining crypto tokens as recited in claim 6, wherein the creating bonding curve and/or the annulling bonding curve is defined as a sequence of multiple curve segments, a curve segment connecting to a subsequent curve segment.

8. The method for maintaining crypto tokens as recited in claim 7, wherein each curve segment is defined by one or more parameters, integrating along each curve segment using an integral of the curve segment, the integral being defined by the parameters.

9. The method for maintaining crypto tokens as recited in claim 7, wherein each curve segment is defined by a polynomial, e.g., a Bezier spline.

10. The method for maintaining crypto tokens as recited in claim 7, wherein computing the first amount of crypto tokens of the first type to be created includes:
computing the integral from the current supply size to the end of a first curve segment associated with the current supply size,
adding precomputed integrals of a number of curve segments following the first curve segment until adding a next curve segment would exceed the second amount,
executing the approximating algorithm on the next curve segment.

11. A server device for maintaining crypto tokens of a first type, the server device comprising:
a communication interface configured to receive a creation request for creating crypto tokens of the first type in exchange for an indicated second amount of crypto tokens of a second type according to a creating bonding curve, the indicated second amount being indicated with the creation request; and
a processor system configured to:
maintain a current supply size indicating the number of crypto tokens of a first type,
process the creation request,
compute a first amount of crypto tokens of the first type to be created in response to the creation request by executing an approximating algorithm for estimating the first amount wherein an integral of the creating bonding curve from the current supply size to the current supply size increased with the first amount equals the indicated second amount to within a threshold;
wherein the processing of the creation request includes increasing the current supply size with the first amount of crypto tokens of the first type, and transferring the first amount of crypto tokens of the first type.

12. A client device for maintaining crypto tokens of a first type, the client device comprising:
a communication interface configured to send a creation request for creating crypto tokens of the first type in exchange for an indicated second amount of crypto tokens of a second type according to a creating bonding curve, the indicated second amount being indicated with the creation request; and
a processor system configured to:
maintain a wallet with crypto tokens of the second type, and to transfer a second amount of crypto tokens of the second type to a pool,
maintain a wallet with crypto tokens of the first type, and to receive a first amount of crypto tokens of the first type,
wherein the amount of crypto tokens of the second type is determined by computing a first amount of crypto tokens of the first type to be created in response to the creation request by executing an approximating algorithm for estimating the first amount wherein an integral of a creating bonding curve from a current supply size to the current supply size increased with the first amount equals the indicated second amount to within a threshold.

13. A non-transitory computer readable medium on which are stored data representing instructions for maintaining crypto tokens of a first type, the instructions, when executed by a processor system, causing the processor system to perform the following steps:
maintaining a current supply size indicating the number of crypto tokens of a first type;
processing a creation request for creating crypto tokens of the first type in exchange for an indicated second amount of crypto tokens of a second type according to a creating bonding curve, the indicated second amount being indicated with the creation request;
computing a first amount of crypto tokens of the first type to be created in response to the creation request by executing an approximating algorithm for estimating the first amount wherein an integral of the creating bonding curve from the current supply size to the current supply size increased with the first amount equals the indicated second amount to within a threshold;
wherein processing the creation request further includes increasing the current supply size with the first amount of crypto tokens of the first type, and transferring the first amount of crypto tokens of the first type.
